(19) United States
(12) Patent Application Publication
(10) Pub. No.: US 2012/0059837 A1
(43) Pub. Date: Mar. 8, 2012

(54) INFORMATION PROCESSING SYSTEM, CONTENT RECORDING/REPRODUCING DEVICE, AND INFORMATION PROCESSING METHOD

(75) Inventor: Hitoshi FUJITA, Osaka (JP)

(73) Assignee: PANASONIC CORPORATION, Osaka (JP)

(21) Appl. No.: 13/296,857

(22) Filed: Nov. 15, 2011

Related U.S. Application Data
(63) Continuation of application No. PCT/JP2010/000800, filed on Feb. 9, 2010.

(30) Foreign Application Priority Data
Jun. 10, 2009 (JP) 2009-139367

(51) Int. Cl. G06F 17/30

(52) U.S. Cl. 707/758; 707/E17.014; 707/E17.01

(57) ABSTRACT

An entry information array includes m pieces of entry information corresponding to m directory entries of n directory entries included in a directory entry array. Each of the pieces of entry information includes name information of the directory entry, and allocation position information indicating allocation position of the directory entry in the directory entry array. The entry information search section detects entry information corresponding to a file or a directory, which is a search target, from the entry information array. The directory entry access section refers to the allocation position information included in the detected entry information to detect a directory entry corresponding to the search target from the directory entry array.

### CROSS-REFERENCE TO RELATED APPLICATION

This is a continuation of PCT International Application PCT/JP2010/000800 filed on Feb. 9, 2010, which claims priority to Japanese Patent Application No. 2009-139367 filed on Jun. 10, 2009. The disclosures of these applications including the specifications, the drawings, and the claims are hereby incorporated by reference in their entirety.

### BACKGROUND

The present disclosure relates to information processing systems and information processing methods, and more particularly to information processing systems and information processing methods executing access to a recording medium hierarchically managed by directories.

Numbers of information processing systems employ a file system having a hierarchical structure to facilitate management of data. Files storing data are managed by a directory, and directories managing files are managed by a superior directory. For example, in a file allocation table (FAT) file system, a file (or directory) is managed by a directory entry including name information, data storage position information, etc. A plurality of directory entries belonging to a same directory are arrayed to form a directory entry array. When a file is searched for, directory search starts from a top directory, and sequential access is executed to the directory entry array corresponding to the directories. When a target directory entry is detected, the search progresses to subordinate files (or directories).

However, in sequential access, since directory entries are sequentially searched one by one from the first directory entry of the directory entry array, the worst access time becomes longer when the directory entry at a later position of the directory entry array is accessed. In recent years, the number of files and directories stored in a recording media increases with an increase in the capacity of a recording medium, a technique of detecting a target file (or directory) at high speed is likely to be expected. For example, in a content recording/reproducing device processing content data such as music, video, images, etc., as-fast-as-possible search for a desired file is required in the nature of the product not to make a user uncomfortable.

As a method of such fast search, hashing is suggested, which converts a search key of a file to an address using a hash function. (See, for example, Japanese Patent Publication No. 2006-236305.) Japanese Patent Publication No. 2006-236305 teaches performing a hash operation on the name of a file, and determining at which position of a directory entry array a directory entry corresponding to the file is to be allocated based on the result of the hash operation.

### SUMMARY

However, in the technique of Japanese Patent Publication No. 2006-236305, as the number of files of which results of operations using a hash function collide (of which operation results indicate equal values) increases, dependency on sequential access increases, thereby lengthening the worst access time.

According to an aspect of the present disclosure, an information processing system accesses a recording medium using an entry information array. The system includes an entry information search section, and a directory entry access section. The recording medium includes a directory entry array including n directory entries, where n is an integer of two or more, belonging to a same directory. Each of the n directory entries corresponds to a file or a subordinate directory entry array belonging to a subordinate directory; and includes name information indicating a name of the file or a name of the subordinate directory, and storage position information indicating storage position of the file or storage position of the subordinate directory entry array corresponding to the subordinate directory. The entry information array includes m pieces of entry information corresponding to m directory entries, where 1≦m≦n, of the n directory entries. Each of the m pieces of entry information includes name information of a directory entry corresponding to the entry information, and allocation position information indicating allocation position of the directory entry corresponding to the entry information in the directory entry array. The entry information search section detects entry information corresponding to a file or a directory, which is a search target, from the entry information array. The directory entry access section refers to the allocation position information included in the entry information detected by the entry information search section to detect a directory entry corresponding to the search target from the directory entry array.

The above-described information processing system accesses a target directory entry using an entry information array without sequentially accessing the directory entry array. This shortens the worst access time.

### BRIEF DESCRIPTION OF THE DRAWINGS

FIG. 1 illustrates an example configuration of an information processing system according to a first embodiment.

FIG. 2 illustrates a directory entry array.

FIG. 3 illustrates an entry information array.

FIG. 4 is a flow chart illustrating data search using the information processing system shown in FIG. 1.

FIG. 5 is a flow chart illustrating data generation using the information processing system shown in FIG. 1.

FIG. 6 is a flow chart illustrating data deletion using the information processing system shown in FIG. 1.

FIG. 7 is a flow chart illustrating entry information generation using the information processing system shown in FIG. 1.

FIG. 8 is a flow chart illustrating entry information deletion using the information processing system shown in FIG. 1.

FIG. 9 illustrates a variation of the information processing system shown in FIG. 1.

FIG. 10 is a flow chart illustrating data generation using the information processing system shown in FIG. 9.

FIG. 11 is a flow chart illustrating data generation using the information processing system shown in FIG. 9.

FIG. 12 illustrates an example configuration of an information processing system according to a second embodiment.

FIG. 13 illustrates data stored in a nonvolatile memory shown in FIG. 12.

FIG. 14 is a flow chart illustrating data search using the information processing system shown in FIG. 12.

FIG. 15 is a flow chart illustrating data generation using the information processing system shown in FIG. 12.

FIG. 16 is a flow chart illustrating data deletion using the information processing system shown in FIG. 12.

### DETAILED DESCRIPTION

Embodiments will be described hereinafter in detail with reference to the drawings. The same reference characters shown in the figures are used to represent the same or equivalent elements, and repetitive explanation will be omitted.

### First Embodiment

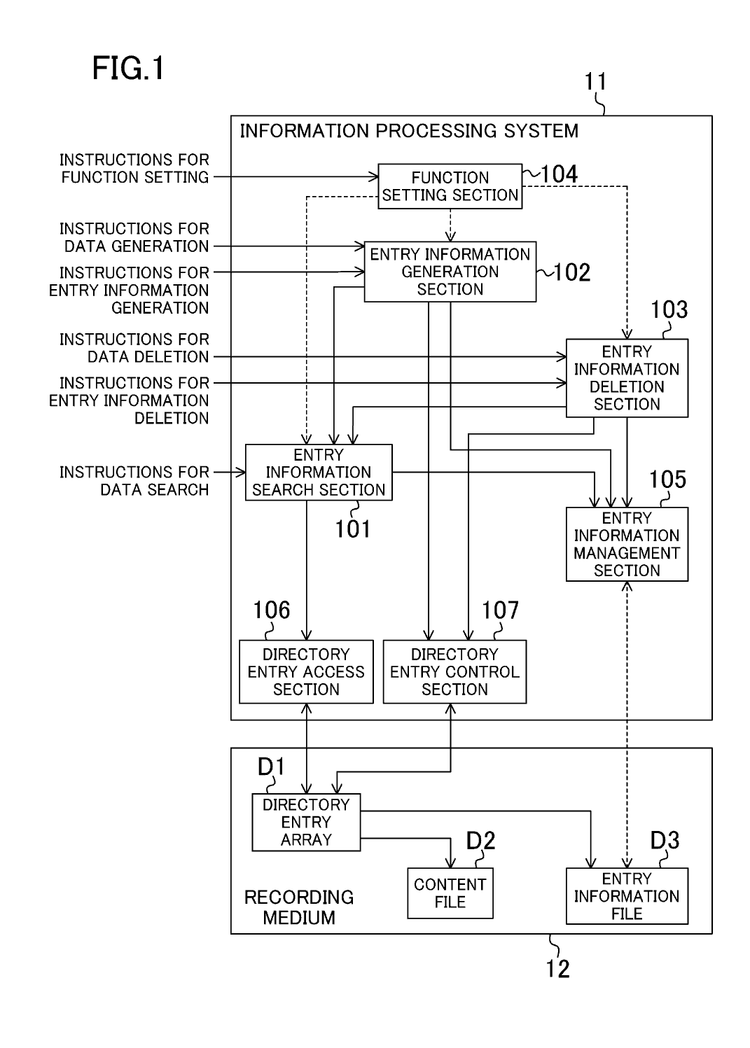

FIG. 1 illustrates an example configuration of an information processing system 11 according to a first embodiment. The information processing system 11 accesses a recording medium 12 using an entry information array stored in the recording medium 12. The information processing system 11 is mounted in a content recording/reproducing device, etc. processing content data such as video, music, images, etc.

### Recording Medium

The recording medium 12 is formatted by a hierarchical file system, and hierarchically managed by a plurality of directories. The recording medium 12 stores a plurality of content files, a plurality of directory entry arrays corresponding to the plurality of directories, and a single or multiple entry information file(s). Each content file stores content data (e.g., music data, image data, video data, etc.). Each entry information file stores an entry information array. Note that FIG. 1 merely shows a single directory entry array D1, a content file D2 and an entry information file D3 corresponding to the directory entry array D1.

### Directory Entry Array

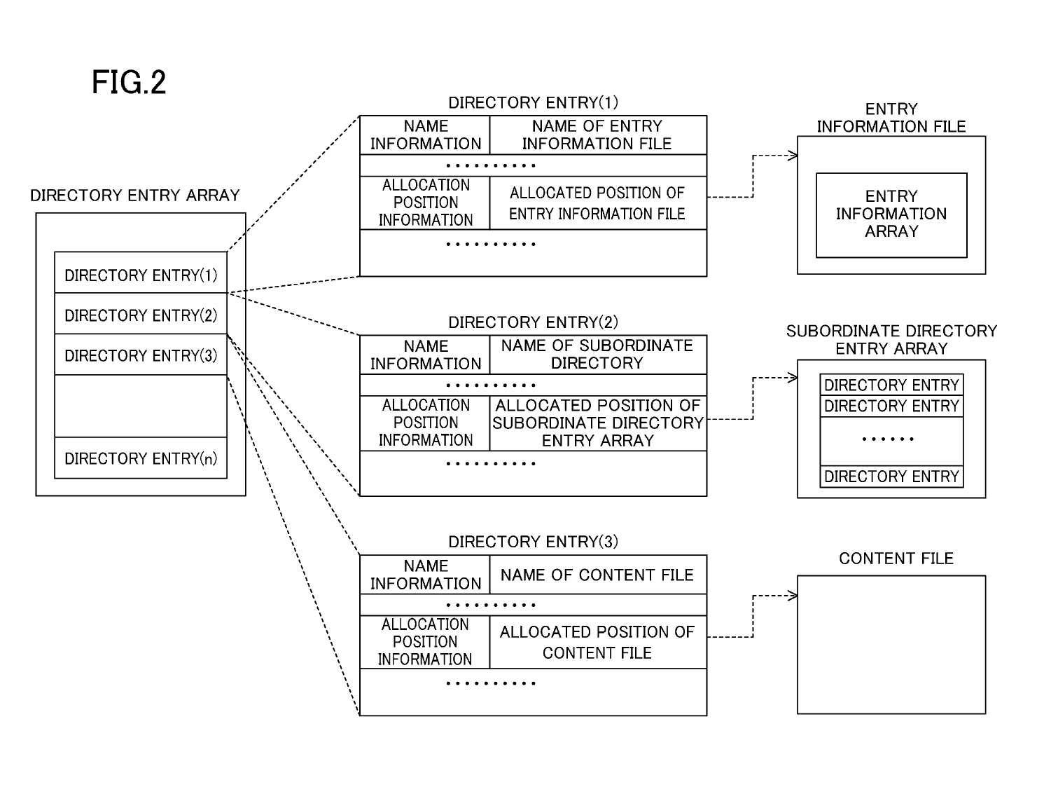

As shown in FIG. 2, each directory entry array includes n directory entries, where n is an integer of two or more, belonging to a same directory. Each of the n directory entries includes name information indicating the name of data (an entry information file, a content file, or a subordinate directory) corresponding to the directory entry, storage position information indicating the storage position of data corresponding to the directory entry, etc. For example, a directory entry (2) corresponds to a subordinate directory, and the name information of the directory entry (2) indicates the name of the subordinate directory, and the storage position information of the directory entry (2) indicates the storage position of the subordinate directory entry array corresponding to the subordinate directory.

A directory entry (a directory entry (1) in FIG. 2) allocated at a predetermined position of the directory entry array corresponds to an entry information file storing an entry information array corresponding to the directory entry array. For example, the name information of the directory entry (1) allocated at the first position of the directory entry array (specifically, at the first position of a general entry region except for a system file region) indicates the name (e.g., a predetermined proper name) of the entry information file, and the storage position information of the directory entry (1) indicates the storage position of the entry information file.

### Entry Information Array

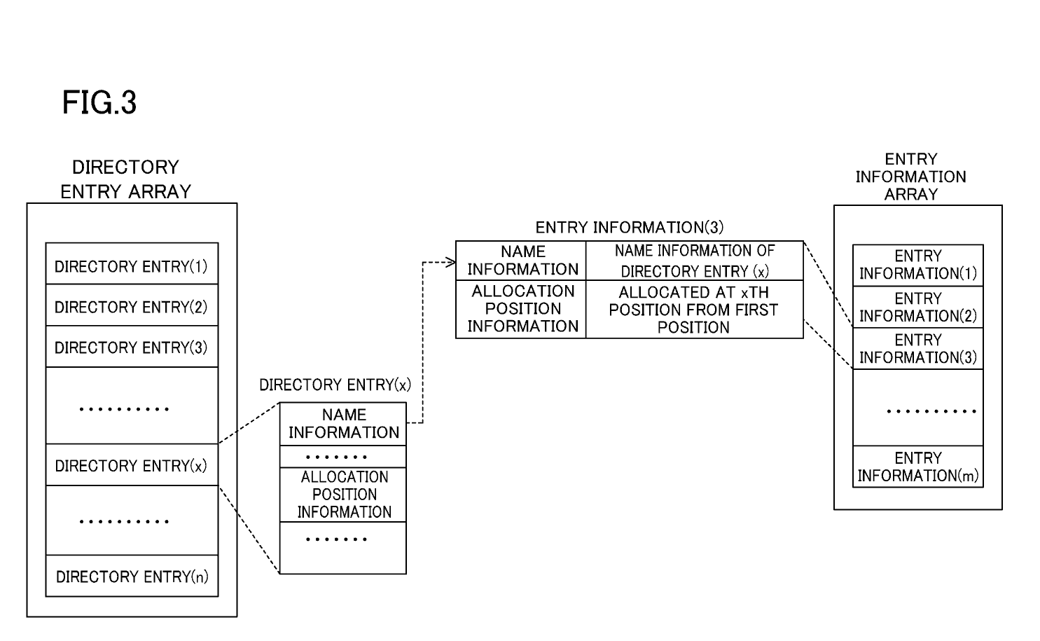

As shown in FIG. 3, the entry information array includes m pieces of entry information, where 1≦m≦n. The m pieces of entry information correspond to m directory entries of the n directory entries. Each of the m pieces of entry information includes the name information of the directory entry corresponding to the entry information, and allocation position information indicating the allocation position of the directory entry corresponding to the entry information. For example, entry information (3) corresponds to a directory entry (X), where 1≦X≦n, allocated at the X^{th} position from the first position, and the entry information (3) includes the name information of the directory entry (X), the allocation position information indicating that the directory entry (X) is allocated at the X^{th} position from the first position of the directory entry array.

### Information Processing System

Referring back to FIG. 1, the information processing system 11 includes, an entry information search section 101, an entry information generation section 102, an entry information deletion section 103, a function setting section 104, an entry information management section 105, a directory entry access section 106, and a directory entry control section 107.

The entry information search section 101 controls the entry information management section 105 and the directory entry access section 106 in response to instructions for data search from a user and instructions from the entry information generation section 102 and the entry information deletion section 103, and executes read-out of the entry information array, search for entry information, search for a directory entry using entry information, sequential access, etc. The entry information search section 101 sequentially searches directories (directory entry arrays) from the top directory (the top directory entry array).

The entry information generation section 102 controls the entry information search section 101, the entry information management section 105, and the directory entry control section 107 in response to instructions for data generation and instructions for entry information generation from a user, and executes addition of a new directory entry, generation of new entry information, addition of new entry information to the entry information array, rewrite of the entry information array, etc.

The entry information deletion section 103 controls the entry information search section 101, the entry information management section 105, and the directory entry control section 107 in response to instructions for data deletion and instructions for entry information deletion from a user, and executes deletion of a directory entry, entry information deletion in the entry information array, rewrite of the entry information array, etc.

The function setting section 104 determines whether or not to enable the entry information search section 101, the entry information generation section 102, and the entry information deletion section 103 (i.e., whether or not to execute directory entry search using entry information) in response to instructions for function setting from a user.

The entry information management section 105 executes read-out of the entry information array, rewrite of the entry information array, etc. in response to instructions from the entry information generation section 102, the entry information search section 101, and the entry information deletion section 103. For example, the entry information management section 105 receives path information (storage position information included in a directory entry) of the directory being searched, and reads out and holds the entry information array from the entry information file based on the path information.

The directory entry access section 106 executes selection of the directory entry array to be processed by the information processing system 11, directory entry search using entry information, sequential access, etc. in response to instructions from the entry information search section 101.

The directory entry control section 107 executes addition/deletion of a directory entry to/from a directory entry array, detection of the allocation position of the directory entry, creation/deletion of an entry information file, positional exchange of directory entries in a directory entry array, etc. in response to instructions from the entry information generation section 102 and the entry information deletion section 103. For example, the directory entry control section 107 receives information on two directory entries belonging to a same directory entry array, and exchanges the positions of the two directory entries in the directory entry array.

### Data Search

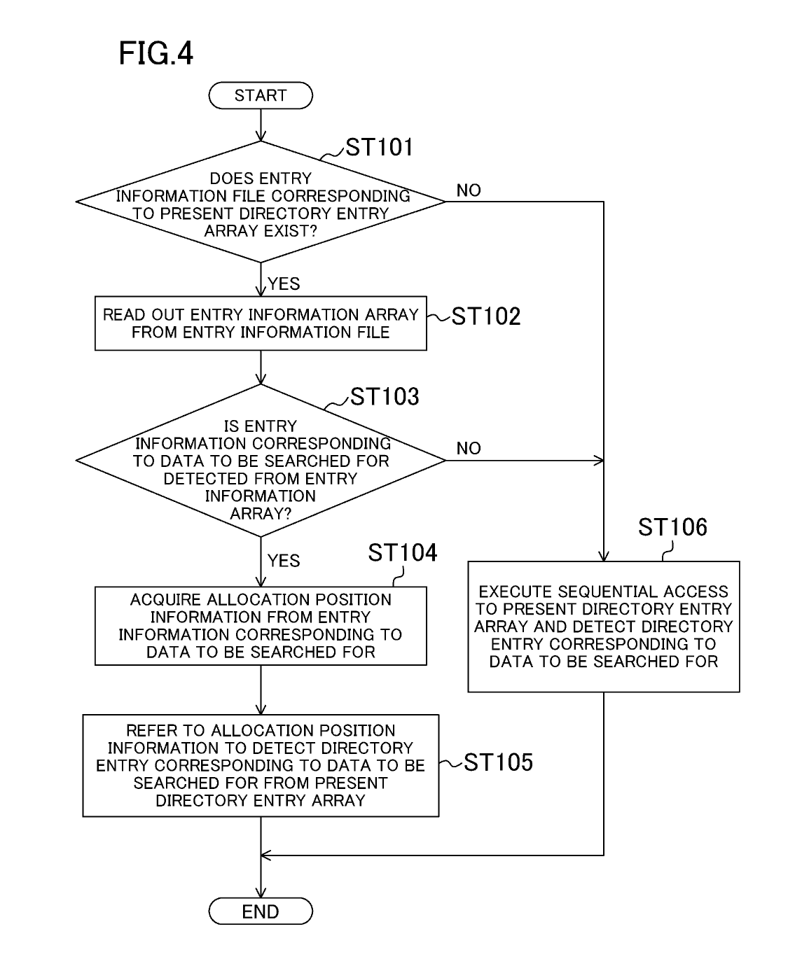

Next, data search using the information processing system 11 shown in FIG. 1 will be described with reference to FIG. 4. In this example, the information processing system 11 searches for the directory entry corresponding to data to be searched for (the content file or the directory entry array to be searched for) in response to instructions for data search. The directory entry array subject to data search is selected.

### ST101

The entry information search section 101 determines whether or not an entry information file corresponding to the present directory entry array (directory entry array selected as a target of data search) exists. For example, the entry information search section 101 determines that the entry information file exists when the name information of the directory entry allocated at the predetermined position (e.g., the first position) of the present directory entry array indicates the name of the entry information file. If the entry information search section 101 determines that an entry information file exits, the process goes to step ST102. If not, the process goes to step ST106.

### ST102

Then, the entry information management section 105 reads out an entry information array from the entry information file corresponding to the present directory entry array. For example, the entry information management section 105 refers to the storage position information included in the directory entry indicating the name of the entry information file, and accesses the entry information file. The entry information array corresponds to the present directory entry array.

### ST103

Next, the entry information search section 101 searches the entry information array for entry information corresponding to the data to be searched for. That is, the entry information search section 101 searches the entry information array for the entry information indicating the name of the data to be searched for. If the entry information corresponding to the data to be searched for is detected, the process goes to step ST104. If not, the process goes to step ST106.

### ST104

Then, the entry information search section 101 acquires allocation position information from the entry information detected in the step ST 103 (the entry information corresponding to the data to be searched for). The allocation position information indicates at which position of the present directory entry array the directory entry corresponding to the data to be searched for is allocated.

### ST105

Next, the directory entry access section 106 does not execute sequential access to the present directory entry array, refers to the allocation position information acquired in the step ST104, detects the directory entry corresponding to the data to be searched for from the present directory entry array, and accesses the directory entry.

### ST106

On the other hand, when it is determined in the step ST101 that no entry information file corresponding to the present directory entry array exists, or when it is determined in the step ST103 that no entry information corresponding to the data to be searched for is detected, the directory entry access section 106 executes sequential access to the present directory entry array, detects the directory entry corresponding to the data to be searched for, and accesses the directory entry.

As described above, with the use of the entry information array, a desired directory entry is detected from a directory entry array without executing sequential access, and thus, the search amount of the directory entry can be reduced. This shortens the worst access time.

An entry information array is stored in an entry information file existing in the recording medium 12. This enables the information processing system 11 to execute access using entry information without storing any entry information array inside the information processing system 11.

### Data Generation

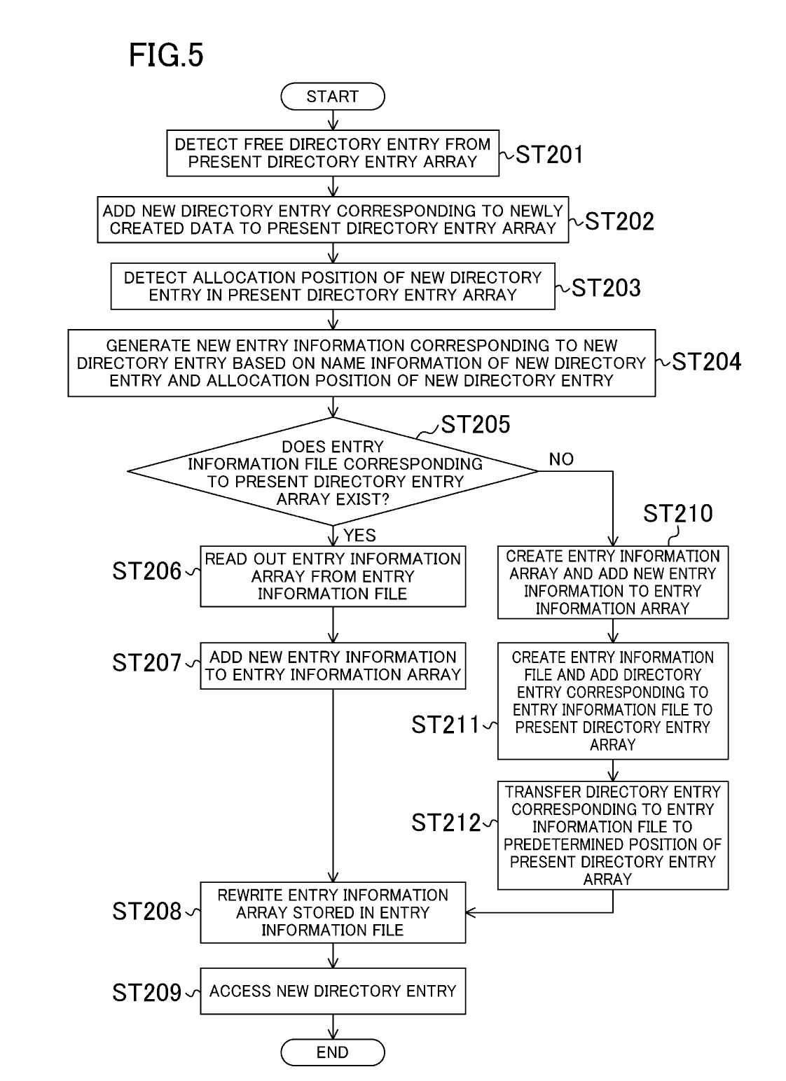

Then, data generation using the information processing system 11 shown in FIG. 1 will be described with reference to FIG. 5. In this example, the information processing system 11 adds new entry information corresponding to newly created data (newly created content file or directory entry array) to the entry information array in response to instructions for data generation. Also, the data search shown in FIG. 4 is executed, and a directory entry array subject to data generation (a directory entry array to which a new directory entry corresponding to newly created data will be added) is selected as the present directory entry array.

### ST201

The entry information search section 101 detects free directory entry (directory entry corresponding to none of the entry information file, the content file, or the subordinate directory entry array) from the present directory entry array.

### ST202

Next, the directory entry control section 107 writes the name of newly created data, the storage position of the newly created data, etc. in a free directory entry. This adds the new directory entry corresponding to the newly created data to the present directory entry array.

### ST203

Then, the directory entry control section 107 detects allocation position of the new directory entry in the present directory entry array (at which position of the present directory entry array the new directory entry is allocated).

### ST204

Next, the entry information generation section 102 generates entry information indicating the name written in the new directory entry (i.e., the name of the newly created data) and the allocation position of the new directory entry. This generates new entry information corresponding to the new directory entry.

### ST205

After that, the entry information search section 101 determines whether or not an entry information file corresponding to the present directory entry array exists. If the entry information search section 101 determines that the entry information file exists, the process goes to step ST206. If not, the process goes to step ST210.

### ST206

Then, the entry information management section 105 reads out an entry information array from the entry information file corresponding to the present directory entry array. This entry information array corresponds to the present directory entry array.

### ST207

Next, the entry information management section 105 adds new entry information generated in the step ST204 to the entry information array read out in the step ST206. As such, the entry information array is updated.

### ST208

After that, the entry information management section 105 rewrites the entry information array stored in the entry information file to the entry information array updated in the step ST207 (or the step ST212).

### ST209

Then, the directory entry access section 106 accesses the new directory entry.

### ST210

On the other hand, when it is determined in the step ST205 that no entry information file corresponding to the present directory entry array exists, the entry information management section 105 creates an entry information array, and adds the new entry information generated in the step ST204 to the entry information array.

### ST211

Next, the directory entry control section 107 detects a free directory entry from the present directory entry array, and writes the name and the storage position of an entry information file to the free directory entry. This newly creates an entry information file, and adds a directory entry corresponding to the entry information file to the present directory entry array.

### ST212

After that, the directory entry control section 107 transfers the directory entry corresponding to the entry information file to a predetermined position (e.g., the first position) of the present directory entry array. For example, the directory entry control section 107 exchanges an existing directory entry allocated at a predetermined position of the present directory entry array and the directory entry corresponding to the entry information file. In this case, the entry information generation section 102 may generate another piece of new entry information corresponding to the existing directory entry subject to the exchange, and may add the other piece of new entry information to the entry information array. This mitigates degradation in access performance due to the exchange of the directory entries. As such, the entry information array is updated. Then, the process goes to the step ST208.

From the above processing, new entry information corresponding to the newly created data is added to the entry information array.

### Data Deletion

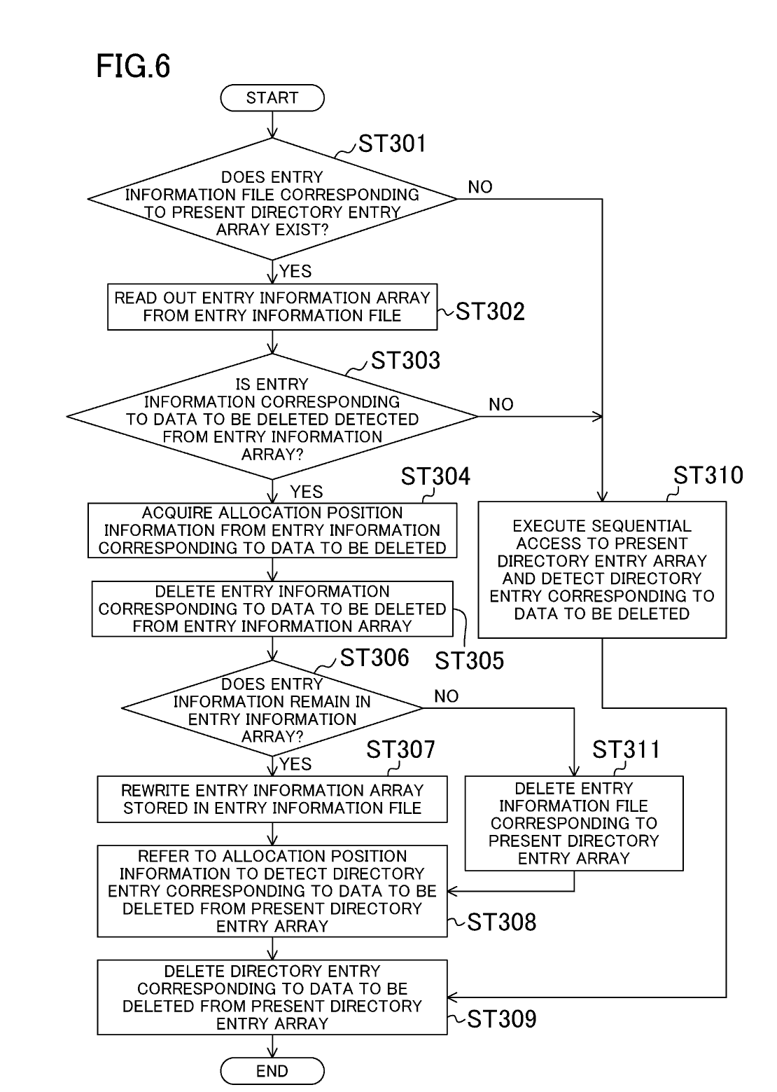

Then, data deletion using the information processing system 11 shown in FIG. 1 will be described with reference to FIG. 6. In this example, the information processing system 11 deletes entry information corresponding to data to be deleted (a content file or a directory entry array to be deleted) in response to instructions for data deletion. Also, the data search shown in FIG. 4 is executed, and a directory entry array subject to data deletion (a directory entry array including a directory entry corresponding to the data to be deleted) is selected as the present directory entry array.

### ST301

The entry information search section 101 determines whether or not an entry information file corresponding to the present directory entry array exists. If the entry information search section 101 determines that the entry information file exists, the process goes to step ST302. If not, the process goes to step ST310.

### ST302

Then, the entry information management section 105 reads out an entry information array from the entry information file corresponding to the present directory entry array. This entry information array corresponds to the present directory entry array.

### ST303

Next, the entry information search section 101 searches the entry information array for the entry information corresponding to the data to be deleted. That is, the entry information search section 101 searches the entry information array for entry information indicating the name of the data to be deleted. If entry information corresponding to the data to be deleted is detected, the process goes to step ST304. If not, the process goes to step ST310.

### ST304

Then, the entry information search section 101 acquires allocation position information from the entry information detected in the step ST303. The allocation position information indicates the allocation position of the directory entry corresponding to the data to be deleted (at which position of the present directory entry array the directory entry corresponding to the data to be deleted is allocated).

### ST305

After that, the entry information management section 105 deletes the entry information detected in the step ST303 (the entry information corresponding to the data to be deleted) from the entry information array read out in the step ST302. As such, the entry information array is updated.

### ST306

Then, the entry information search section 101 determines whether or not entry information remains in the entry information array. If the entry information search section 101 determines that entry information remains in the entry information array, the process goes to step ST307. If not, the process goes to step ST311.

### ST307

Next, the entry information management section 105 rewrites the entry information array stored in the entry information file to the entry information array updated in the step ST305.

### ST308

After that, the directory entry access section 106 does not execute sequential access to the present directory entry array, refers to the allocation position information acquired in the step ST304, detects the directory entry corresponding to the data to be deleted for from the present directory entry array, and accesses the directory entry.

### ST309

Next, the directory entry control section 107 deletes the directory entry corresponding to the data to be deleted from the present directory entry array.

### ST310

On the other hand, when it is determined in the step ST301 that no entry information file corresponding to the present directory entry array exists, or when it is determined in the step ST303 that no entry information corresponding to the data to be deleted is detected, the directory entry access section 106 executes sequential access to the present directory entry array, detects the directory entry corresponding to the data to be deleted, and accesses the directory entry. Then, the process goes to the step ST309.

### ST311

When it is determined in the step ST306 that no entry information remains in the entry information array, the directory entry control section 107 deletes the entry information file corresponding to the present directory entry array. That is, the directory entry control section 107 deletes the directory entry corresponding to the entry information file from the present directory entry array. Then, the process goes to the step ST308.

From the above processing, new entry information corresponding to the data to be deleted is deleted from the entry information array.

### Entry Information Generation

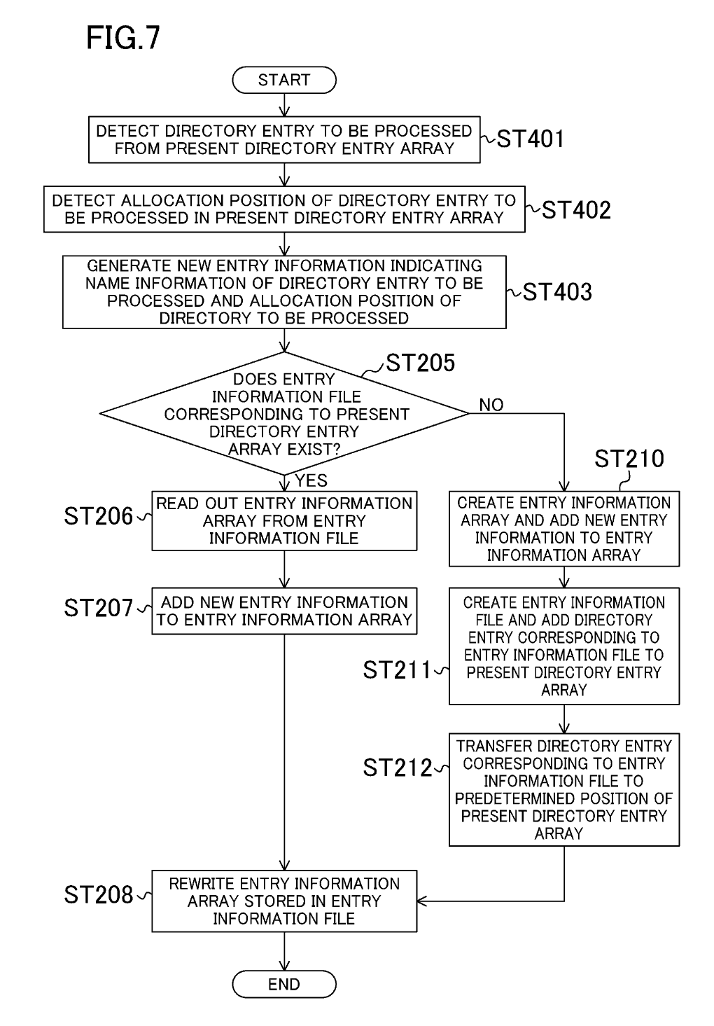

Then, entry information generation using the information processing system 11 shown in FIG. 1 will be described with reference to FIG. 7. In this example, the information processing system 11 allows new entry information to correspond to a directory entry not corresponding to entry information in response to instructions for entry information generation. Also, the data search shown in FIG. 4 is executed, and the directory entry array subject to entry information generation (a directory entry array including a directory entry to correspond to the new entry information) is selected as the present directory entry array.

### ST401

The directory entry control section 107 detects the directory entry to be processed (the directory to correspond to new entry information) from the present directory entry array.

### ST402

Then, the directory entry control section 107 detects allocation position of the directory entry to be processed in the present directory entry array (at which position of the present directory entry array the directory entry to be processed is allocated).

### ST403

Next, the entry information generation section 102 generates new entry information indicating the name information of the directory entry to be processed, and the allocation position of the directory to be processed, which has been detected in the step ST402. This generates the new entry information corresponding to the directory to be processed. Then, the process goes to the step ST205.

### ST205-ST208, ST210-ST212

After that, the steps ST205-ST208 and ST210-ST212 are executed. Note that in the steps ST207 and ST210, the new entry information file generated in the step ST403 (the entry information file corresponding to the directory entry to be processed) is added to the entry information array.

From the above processing, new entry information corresponding to an existing directory entry can be added to the entry information array. For example, when the information processing system 11 is used in a device which goes back to the state prior to power-off at power-on, start-up time of the device can be shortened by adding the new entry information corresponding to the file, which has been used immediately before the power-off, to the entry information array.

### Entry Information Deletion

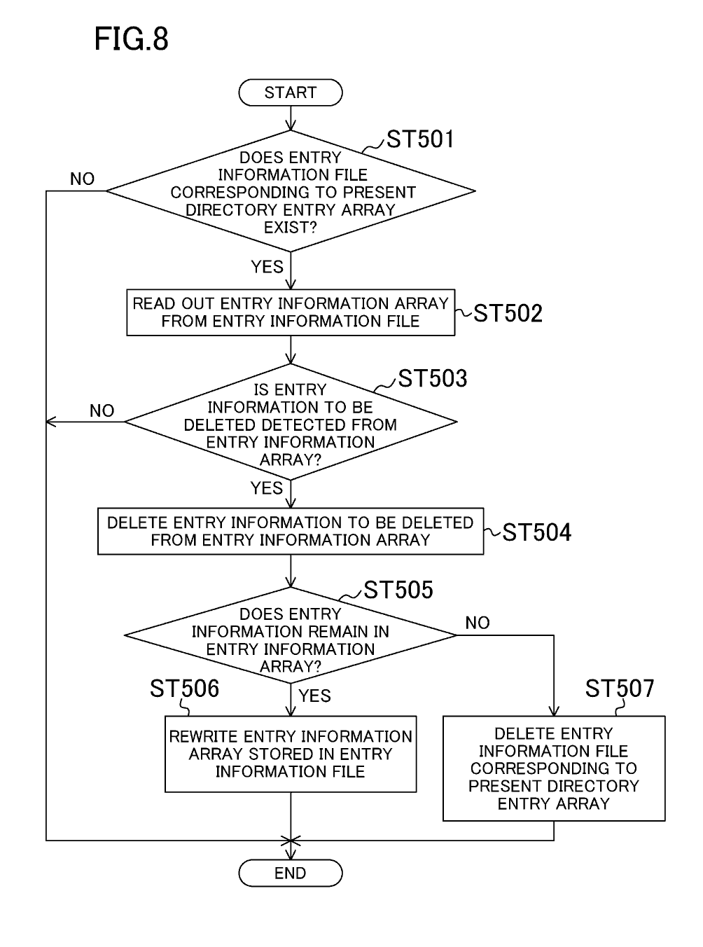

Then, entry information deletion using the information processing system 11 shown in FIG. 1 will be described with reference to FIG. 8. In this example, the information processing system 11 deletes entry information included in the entry information array in response to instructions for entry information deletion. Also, the data search shown in FIG. 4 is executed, and the directory entry array subject to entry information deletion is selected as the present directory entry array.

### ST501

The entry information search section 101 determines whether or not an entry information file corresponding to the present directory entry array exists. If the entry information search section 101 determines that the entry information file exists, the process goes to step ST502. If not, the processing ends.

### ST502

Then, the entry information management section 105 reads out an entry information array from the entry information file corresponding to the present directory entry array. This entry information array corresponds to the present directory entry array.

### ST503

Next, the entry information search section 101 searches the entry information array for entry information to be deleted. If the entry information to be deleted is detected, the process goes to step ST504. If not, the processing ends.

### ST504

The directory entry control section 107 deletes the entry information detected in the step ST503 (the entry information to be deleted) from the entry information array read out in the step ST502. As such, the entry information array is updated.

### ST505

Then, the entry information search section 101 determines whether or not entry information remains in the entry information array. If the entry information search section 101 determines that entry information remains in the entry information array, the process goes to step ST506. If not, the process goes to step ST507.

### ST506

Next, the entry information management section 105 rewrites the entry information array stored in the entry information file to the entry information array updated in the step ST504.

### ST507

On the other hand, when it is determined in the step ST505 that no entry information remains in the entry information array, the directory entry control section 107 deletes the entry information file corresponding to the present directory entry array. That is, the directory entry control section 107 deletes the directory entry corresponding to the entry information file from the present directory entry array.

From the above processing, only entry information can be deleted without deleting the directory entry corresponding to the entry information.

### Variation of First Embodiment

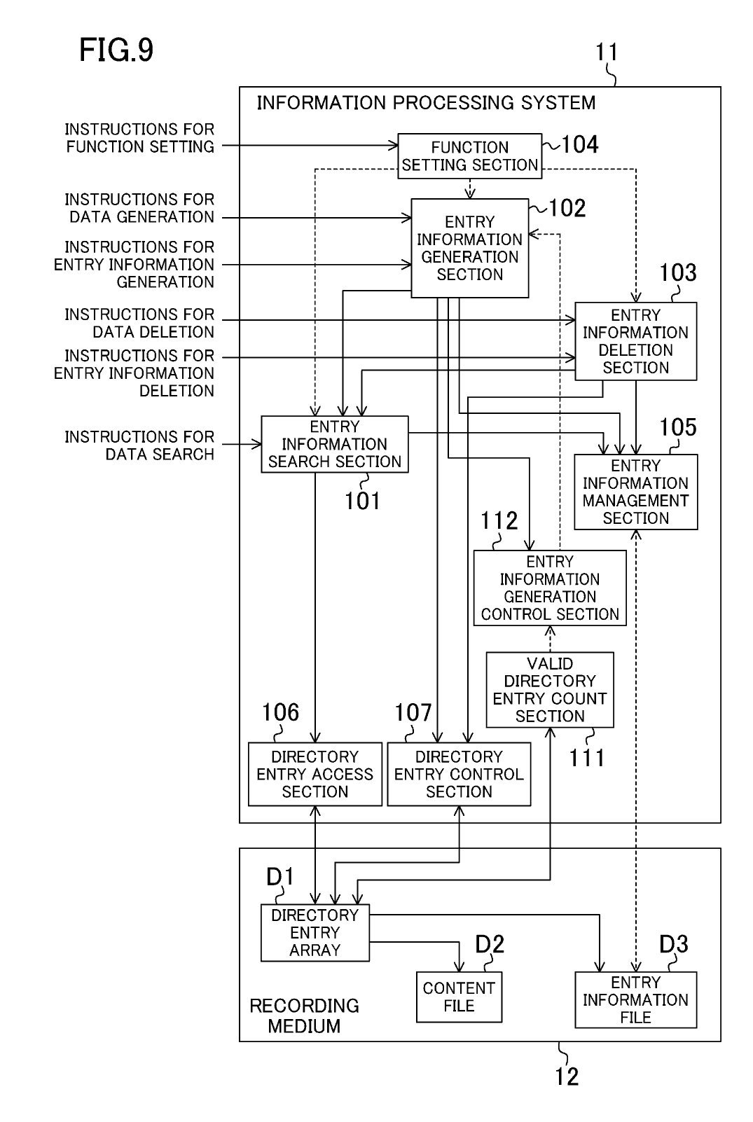

Note that the information processing system 11 may further include a valid directory entry count section 111 and an entry information generation control section 112 shown in FIG. 9. The valid directory entry count section 111 counts the number of the directory entries each corresponding to the file (or directory) belonging to the present directory. That is, the valid directory entry count section 111 counts the number of valid directory entries (the directory entries each corresponding to the file or the subordinate directory entry array) of the present directory entry array. The entry information generation control section 112 reduces generation of entry information by the entry information generation section 102 when the count value (the number of valid directory entries) counted by the valid directory entry count section 111 is smaller than a predetermined threshold value.

### Data Generation

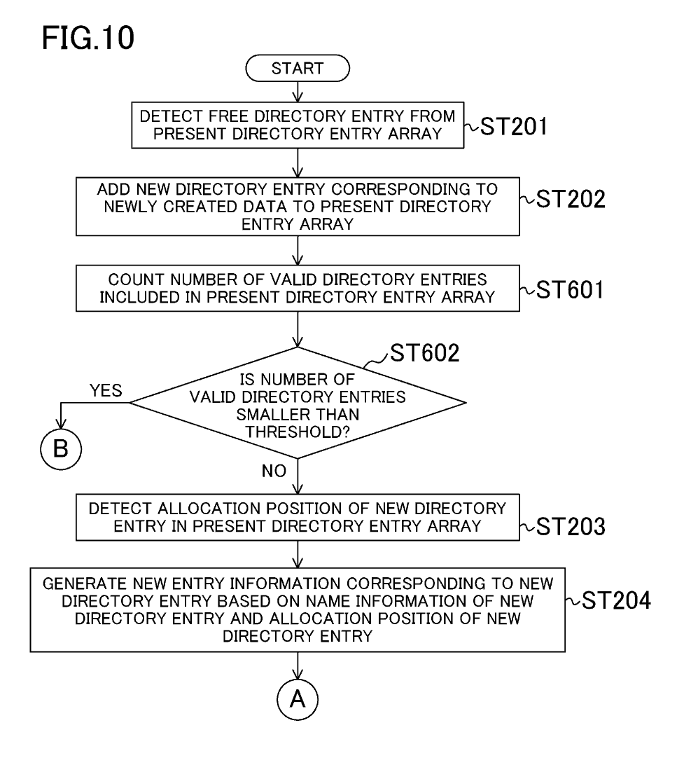

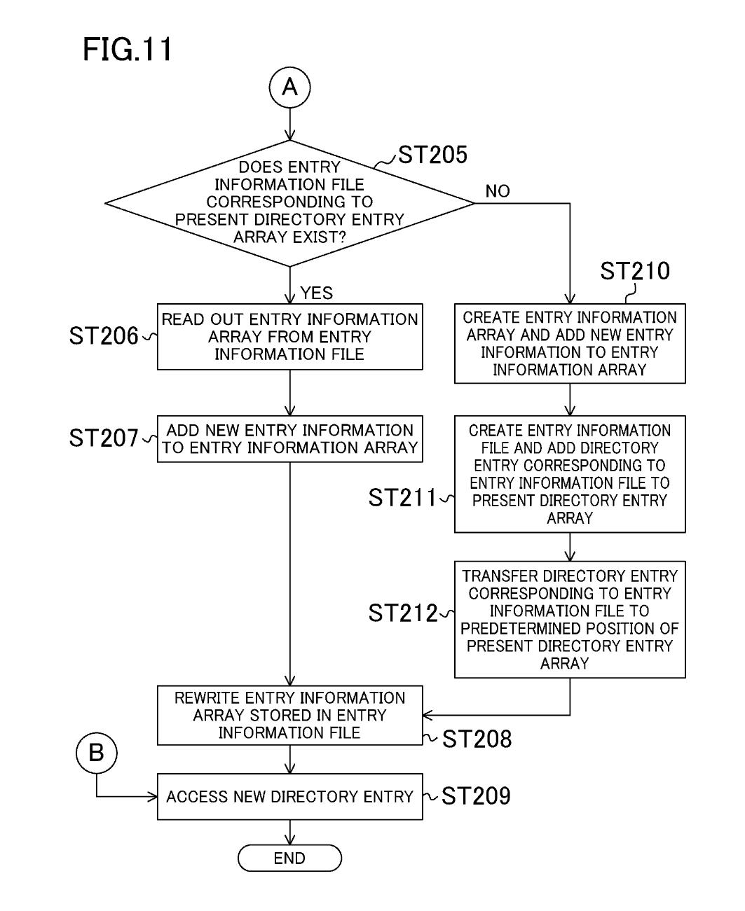

Then, data generation using the information processing system 11 shown in FIG. 9 will be described with reference to FIGS. 10 and 11. In this example, steps ST601 and ST602 are executed between the steps ST202 and ST203 shown in FIG. 5. The other steps are similar to those in FIG. 5.

### ST201, ST202

The steps ST201 and 202 are executed, thereby adding a new directory entry corresponding to newly created data to the present directory entry array.

### ST601

Then, the valid directory entry count section 111 counts the number of valid directory entries (directory entries each corresponding to the content file or directory) included in the present directory entry array.

### ST602

Next, the entry information generation control section 112 determines whether or not the number of the valid directory entries is smaller than a threshold. If the number of the valid directory entries is smaller than the threshold, the process goes to step ST209. If not, the process goes to the step ST203.

As described above, generation of entry information can be reduced in accordance with the number of valid directory entries. The closer the allocation position of the directory entry corresponding to the entry information is to the end of the directory entry array, the greater the advantage of the entry information (the advantage of shortening the worst access time) becomes. Thus, by reducing generation of entry information in accordance with the number of the valid directory entries, entry information can be generated focusing on the directory entry providing the greater advantage.

Second Embodiment

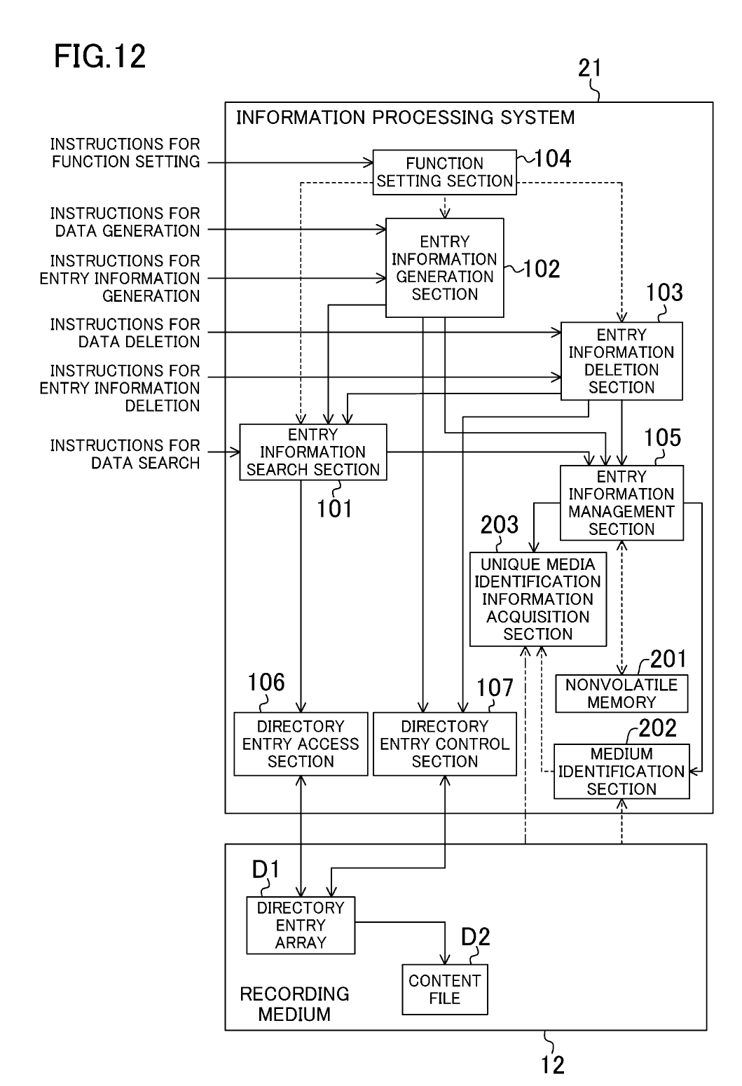

FIG. 12 illustrates an example configuration of an information processing system 21 according to a second embodiment. The information processing system 21 accesses the recording medium 12 using an entry information array stored inside the information processing system 21. The information processing system 21 is mounted in a content recording/reproducing device etc. processing content data such as video, music, images, etc. The information processing system 21 includes a nonvolatile memory 201, a medium identification section 202, and a unique media identification information acquisition section 203 in addition to the configuration of the information processing system shown in FIG. 11. Note that, in this embodiment, the recording medium 12 stores no entry information array, and the directory entry control section 107 does not execute positional exchange of directory entries.

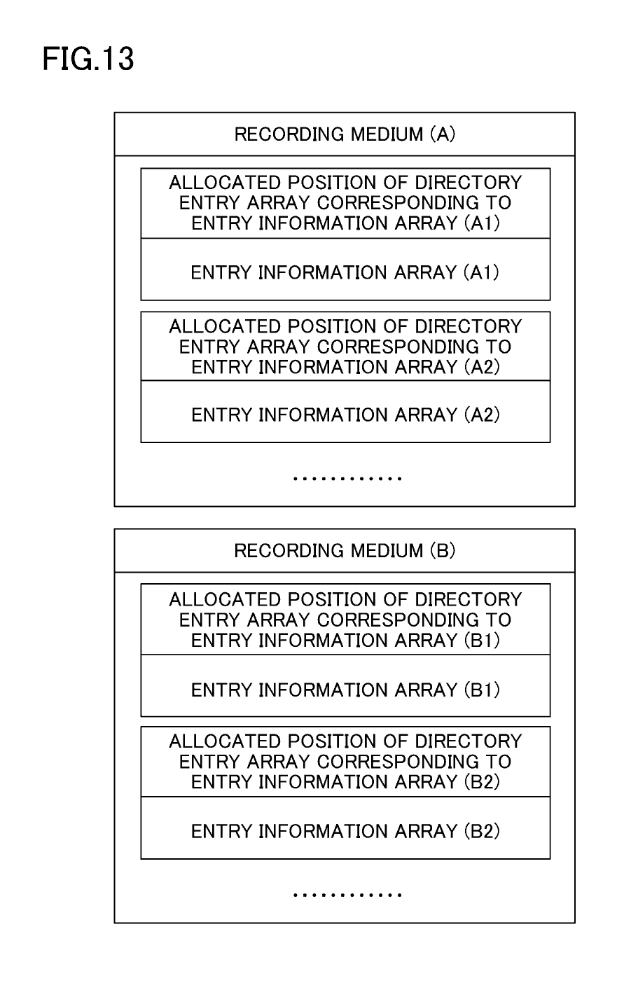

The nonvolatile memory 201 stores a single or multiple entry information array(s). The data structure of the entry information array(s) is the same as the data structure shown in FIG. 3. As shown in FIG. 13, each of the entry information arrays corresponds to medium information indicating the type of the recording medium corresponding to the entry information array, and directory information indicating the storage position of the directory entry corresponding to the entry information array. For example, an entry information array (Al) corresponding to the directory entry array stored in the recording medium (A) corresponds to the medium information indicating the type of the recording medium (A), and the directory information indicating the storage position of the directory entry array corresponding to the entry information array (Al). That is, entry information arrays corresponding to a same recording medium correspond to same medium information. A single entry information array corresponds to a single piece of directory information.

The medium identification section 202 determines the type of the recording medium 12 coupled to the information processing system 21. For example, the medium identification section 202 determines whether or not the recording medium 12 coupled to the information processing system 21 is a recording medium (e.g., SD card) having unique medium identification information (information indicating the type of the recording medium).

The unique media identification information acquisition section 203 acquires the unique medium identification information from the recording medium 12, when the medium identification section 202 determines that the recording medium 12 coupled to the information processing system 21 is a recording medium having unique medium identification information.

The entry information management section 105 reads out and holds an entry information array from the nonvolatile memory 201 in accordance with the unique medium identification information acquired by the unique media identification information acquisition section 203, and path information of the directory searched at present. Also, the entry information management section 105 executes writing of the held entry information array to the nonvolatile memory 201, and addition/deletion of entry information to/from the held entry information array.

### Data Search

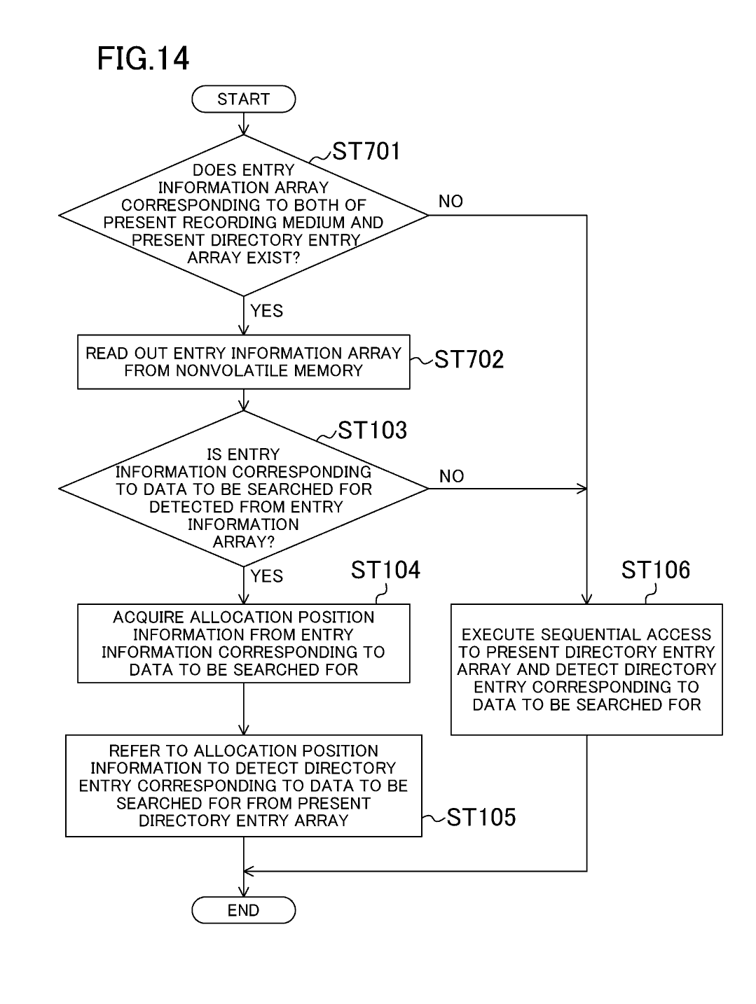

Next, data search using the information processing system 21 shown in FIG. 12 will be described with reference to FIG. 14. In this example, steps ST701 and ST702 are executed instead of the steps ST101 and ST102 shown in FIG. 1. The other steps are similar to those in FIG. 1.

### ST701

The entry information search section 101 determines whether or not an entry information array corresponding to both of the present recording medium (the recording medium coupled to the information processing system 21) and the present directory entry array exists. If the entry information array exists, the process goes to step ST702. If not, the process goes to step ST106.

### ST702

Next, the entry information management section 105 reads out the entry information array corresponding to both of the present recording medium and the present directory entry array from the nonvolatile memory 201. Then, the process goes to the step ST103.

### Data Generation

After that, data generation using the information processing system 21 shown in

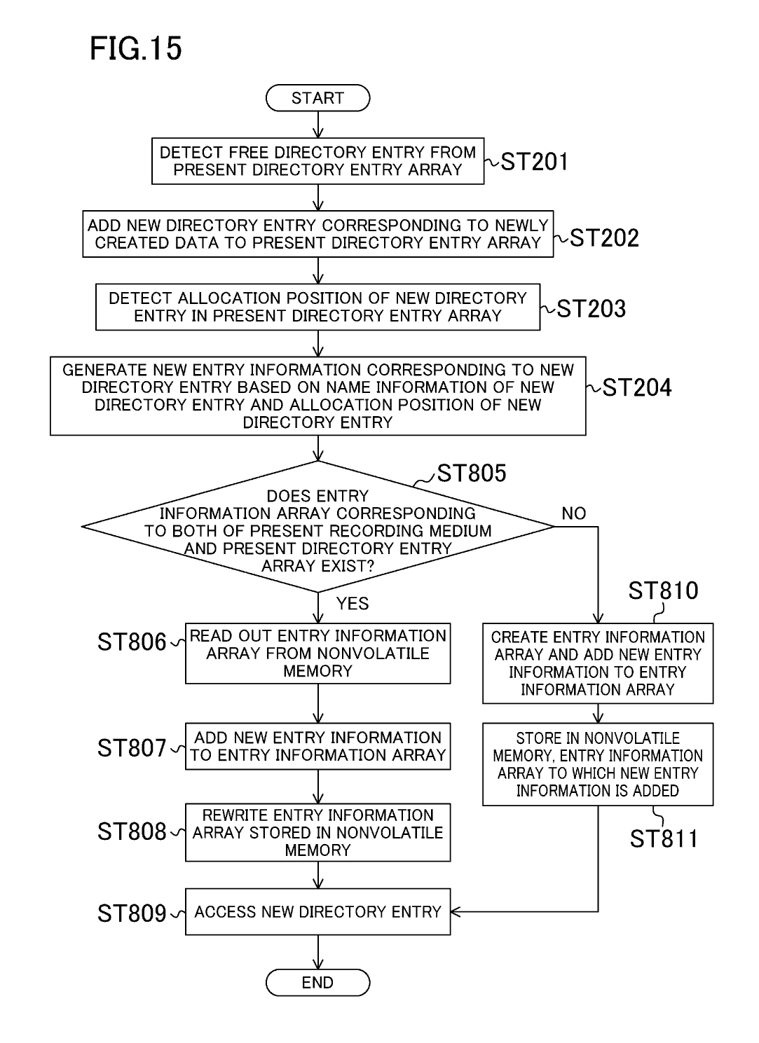

FIG. 12 will be described with reference to FIG. 15. In this example, steps ST805-ST811 are executed instead of the steps ST205-ST212 shown in FIG. 5. The other steps are similar to those in FIG. 5.

ST201-ST204

The steps ST201-ST204 are executed. Specifically, in the step ST202, the new directory entry corresponding to newly created data is added to the present directory entry array. In the step ST203, the allocation position of the new directory entry is detected. In the step ST204, the new entry information corresponding to the new directory entry is generated.

### ST805

Then, the entry information search section 101 determines whether or not an entry information array corresponding to both of the present recording medium and the present directory entry array exits. If the entry information array exists, the process goes to step ST806. If not, the process goes to step ST810.

### ST806

Next, the entry information management section 105 reads out the entry information array corresponding to both of the present recording medium and the present directory entry array from the nonvolatile memory 201.

### ST807

After that, the entry information management section 105 adds the new entry information generated in the step ST204 to the entry information array read out in the step ST806. As such, the entry information array is updated.

### ST808

Then, the entry information management section 105 rewrites the entry information array corresponding to both of the present recording medium and the present directory entry of the entry information arrays stored in the nonvolatile memory 201 to the entry information array updated in the step ST807.

### ST809

Next, the directory entry access section 106 accesses the new directory entry.

### ST810

On the other hand, when it is determined in the step ST805 that no entry information array corresponding to both of the present recording medium and the present directory entry array exists, the entry information management section 105 creates an entry information array, and adds the new entry information to the entry information array.

### ST811

Next, the entry information management section 105 allows the entry information array, to which the new entry information is added in the step ST810, to correspond to both of the present storage medium and the present directory entry array, and stores the entry information array in the nonvolatile memory 201. That is, the entry information management section 105 allows the entry information array, to which the new entry information is added, to correspond to medium information indicating the type of the present storage medium and directory information indicating the storage position of the present directory entry array. Then, the process goes to the step ST809.

### Data Deletion

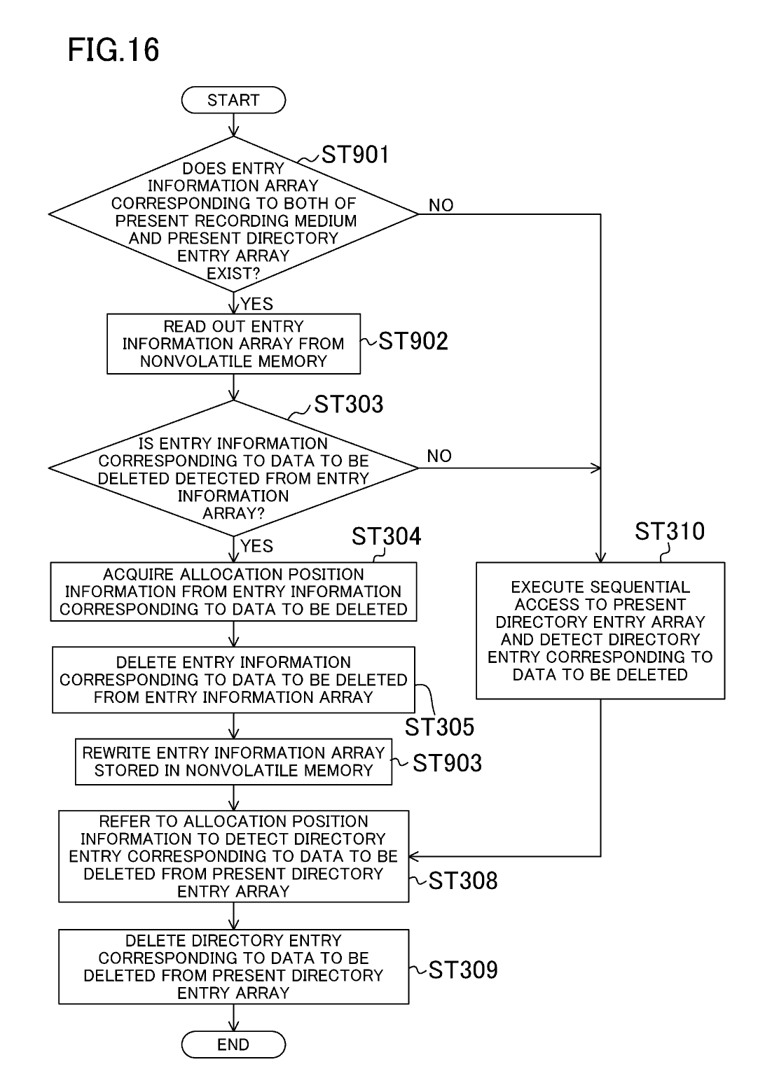

Then, data deletion using the information processing system 21 shown in FIG. 12 will be described with reference to FIG. 16. In this example, steps ST901-ST903 are executed instead of the steps ST301, ST302, ST306, ST307, and ST311 shown in FIG. 6. The other steps are similar to those in FIG. 6.

### ST901

The entry information search section 101 determines whether or not an entry information array corresponding to both of the present recording medium and the present directory entry array exists. If an entry information array exists, the process goes to step ST902. If not, the process goes to the step ST310.

### ST902

After that, the entry information management section 105 reads out the entry information array corresponding to both of the present recording medium and the present directory entry array from the nonvolatile memory 201. Then, the process goes to the step ST303.

### ST303-ST305

Next, the steps ST303-ST305 are executed. In the step ST304, allocation position information (allocation position information indicating the allocation position of the directory entry corresponding to data to be deleted) is acquired. In the step ST305, the entry information array is updated.

### ST903

Then, the entry information management section 105 rewrites the entry information array corresponding to both of the present recording medium and the present directory entry array of the entry information arrays stored in the nonvolatile memory 201 to the entry information array updated in the step ST305 (the entry information array from which the entry information corresponding to the data to be deleted is deleted). After that, the process goes to the step ST308.

As described above, with the use of an entry information array, a desired directory entry can be detected from the directory entry arrays without executing sequential access. The search amount of the directory entry is deleted. This shortens the worst access time.

An entry information array is stored in the nonvolatile memory 201 provided inside the information processing system 21, thereby reducing the number of accesses to the recording medium 12.

Furthermore, an entry information array can be stored for each function of the information processing system 21. For example, when the information processing system 21 has a plurality of functions, an entry information array is provided for each of the functions, and the entry information arrays are rewritten and uses, thereby providing the information processing system 21 with access performance specialized in each function. Note that the information processing system 21 shown in FIG. 12 may further include the valid directory entry count section 111 and the entry information generation control section 112 shown in FIG. 9.

In the above embodiments, the entry information generation section 102, the entry information search section 101, the entry information deletion section 103, the function setting section 104, the entry information management section 105, the directory entry access section 106, the directory entry control section 107, the valid directory entry count section 111, the entry information generation control section 112, the medium identification section 202, and the unique media identification information acquisition section 203 may be MPUs, memories, etc. The procedure of each processing is usually implemented by software (a program), which is recorded in a recording medium such as a ROM. Such software may be distributed by software download, etc., or by recording in a recording medium such as a CD-ROM. The above sections may be hardware (exclusive circuits). The processing by the information processing systems 11 and 21 may be interrupted by power-off or an end of processing.

Processing described in the embodiments may be intensive processing using a single device (system) or distributed processing using a plurality of devices. The number of the computer(s) executing the above programs may be one or more. That is, intensive processing or distributed processing may be performed.

As described above, the information processing system improves the worst access time by using an entry information array, and is thus preferably used for a content recording/reproducing device etc. processing content data such as video, music, and images.

The present disclosure is not limited to the above-described embodiments and may be variously modified. Such modification is clearly included within the scope of the present disclosure.

What is claimed is:

1. An information processing system for accessing a recording medium using an entry information array, the system comprising:
an entry information search section, and
a directory entry access section, wherein
the recording medium includes a directory entry array including n directory entries, where n is an integer of two or more, belonging to a same directory,
each of the n directory entries corresponds to a file or a subordinate directory entry array belonging to a subordinate directory, and includes
name information indicating a name of the file or a name of the subordinate directory, and
storage position information indicating storage position of the file or storage position of the subordinate directory entry array corresponding to the subordinate directory,
the entry information array includes m pieces of entry information, where 1≦m≦n, corresponding to m directory entries of the n directory entries,
each of the m pieces of entry information includes
name information of a directory entry corresponding to the entry information, and
allocation position information indicating allocation position of the directory entry corresponding to the entry information in the directory entry array, p1 the entry information search section detects entry information corresponding to a file or a directory, which is a search target, from the entry information array, and
the directory entry access section refers to the allocation position information included in the entry information detected by the entry information search section to detect a directory entry corresponding to the search target from the directory entry array.

2. The information processing system of claim 1 further comprising
an entry information management section, wherein
the recording medium stores an entry information file indicating the entry information array, and
the entry information file corresponds to a directory entry allocated at a predetermined position of the directory entry array of the n directory entries.

3. The information processing system of claim 2 further comprising:
a directory entry control section configured to exchange two directory entries included in the directory entry array; and
an entry information management section configured to execute read-out of the entry information array stored in the entry information file, and rewriting of the entry information array stored in the entry information file.

4. The information processing system of claim 1 further comprising:
a nonvolatile memory storing the entry information array;
a medium identification section configured to determine whether or not the recording medium has unique identification information;
a unique media identification information acquisition section configured to acquire the unique identification information of the recording medium; and
an entry information management section configured to execute read-out of entry information array stored in the nonvolatile memory using the unique identification information of the recording medium, and rewriting of the entry information array stored in the nonvolatile memory.

5. The information processing system of claim 1 further comprising:
an entry information generation section configured to generate new entry information corresponding to a new directory entry and to add the new entry information to the entry information array when adding the new directory entry to the directory entry array;
an entry information deletion section configured to delete entry information corresponding to a directory entry to be deleted from the entry information array when deleting the directory entry from the directory entry array; and
a function setting section configured to set whether the entry information search section, the entry information generation section, and the entry information deletion section are enabled or disabled.

6. The information processing system of claim 1 further comprising:
an entry information generation section configured to generate new entry information corresponding to a directory entry of the directory entry arrays, which does not correspond to any entry information, and to add the new entry information to the entry information array; and
an entry information deletion section configured to detect entry information to be deleted from the entry information array and to delete the entry information to be deleted from the entry information array.

7. The information processing system of claim 5 further comprising:
a valid directory entry count section configured to count the number of valid directory entries of the n directory entries included in the directory entry array; and
an entry information generation control section configured to block a function of the entry information generation section when a count result by the valid directory entry count section is smaller than a predetermined threshold value.

8. A content recording/reproducing device comprising
the information processing system of claim 1.

9. A method of accessing a recording medium using an entry information array, the method comprising:
searching entry information; and
accessing a directory entry, wherein
the recording medium includes a directory entry array including n directory entries, where n is an integer of two or more, belonging to a same directory,
each of the n directory entries corresponds to a file or a subordinate directory entry array belonging to a subordinate directory, and includes
name information indicating a name of the file or a name of the subordinate directory, and
storage position information indicating storage position of the file or storage position of the subordinate directory entry array corresponding to the subordinate directory,
the entry information array includes m pieces of entry information, where 1≦m≦n, corresponding to m directory entries of the n directory entries,
each of the m pieces of entry information includes
name information of a directory entry corresponding to the entry information, and
allocation position information indicating allocation position of the directory entry corresponding to the entry information in the directory entry array,
entry information corresponding to a file or a directory, which is a search target, is detected from the entry information array, in the searching the entry information, and
the allocation position information included in the entry information detected in the searching the entry information is referred to to detect a directory entry corresponding to the search target from the directory entry array in the accessing the directory entry.
